(19) United States
(12) Patent Application Publication
(10) Pub. No.: US 2005/0149756 A1
(43) Pub. Date: Jul. 7, 2005

(54) Methods and apparatus for monitoring a plurality of individuals

(76) Inventors: Marco H. Bunge, BG Bussum (NL); Martin F. De Jong, Amsterdam (NL); Kees Van Mourik, Amsterdam (NL); George Witteveen, Amsterdam (NL)

Correspondence Address: HOFFMAN WARNICK & D'ALESSANDRO, LLC, 3 E-COMM SQUARE, ALBANY, NY, 12207, US

(21) Appl. No.: 10/979,599

(22) Filed: Nov. 2, 2004

(30) Foreign Application Priority Data
May 2, 2003 (WO) PCT/EP03/04840
May 3, 2002 (GB) 0210248.1
Feb. 12, 2003 (GB) 0303203.4

(51) Int. Cl. H04L 9/00

(52) U.S. Cl. 713/201

(57) ABSTRACT

When any of a set of individual access computing services provided by geographically distributed computer units (e.g., websites), the fact that they are accessing those websites is transmitted to each of the other individuals in real time. The transmission is performed by each of the computer units directly transmitting signals addressed to each of the other computing units over a telecommunications network in packets addressed to the other computing units. Each of the individuals may view a display collating the information received from the computing units. In the case that the computer units are servers supporting Websites, the individuals can select Webpages to view based on the display. In this way, the activity of the group of individuals may be coordinated within space defined by geographically distributed computer units.

### FIELD OF THE INVENTION

The present invention relates to methods and apparatus for monitoring the activities (and optionally other characteristics) of a plurality of individuals in real time.

### BACKGROUND OF THE INVENTION

Modern telecommunication networks permit a plurality of individuals to interact in real time. Traditional communications networks such as telephone systems are characterized in that they permit real-time communication at high information transmission rates (e.g. sufficient for voice conversations) between a very small number of individuals who explicitly choose with whom they communicate (e.g. by dialling a number). The Internet has permitted a generalisation of this concept.

Nowadays, many sites exist on which multiple individuals can communicate in real time. Such sites are supported by a single server (i.e. computer apparatus in a single geographical location). When individuals establish connection with certain such sites, groups of individuals are temporarily associated (e.g. at random) and may exchange information in real time, for example to discuss a topic or to play a game. Furthermore, some such sites allow semi-permanent logical relationships to be defined among the individuals (for example, individuals registered with the site may select other registered individuals, and the sites may store an association between these individuals.)

In either case, the server may monitor whether any of the individuals are connected to it, and notify the associated individuals accordingly. For example, in the case of a site which supports a chess game between individuals paired at random, the server notifies either of the individuals when the other individual has severed his communication with the site. Similarly, some servers supporting semi-permanent logical relationships continually monitor which individuals are accessing them, and upon determining that any first individual is presently interacting with the site, notify that fact to any other individual who is also presently interacting with the site and who has a defined a logical relationship to the first individual.

The present inventors observe that there are several problems with such systems. Firstly, on a technical level, there is the problem that they are highly sensitive to failure of the single server which supports the site, and performs the monitoring operation. Secondly, and on a more conceptual level, there is the problem that the degree of monitoring permitted is severely limited, essentially to whether defined individuals are accessing a given site.

### SUMMARY OF THE INVENTION

The present invention attempts to move beyond the monitoring paradigm defined by the above systems.

A first aspect of the invention proposes in general terms that data should be made available in real-time to each of a set of individuals indicating the instantaneous activities of other individuals of the set in accessing a plurality of computing units (such as different servers supporting different web sites).

Specifically, the first aspect of the invention proposes a method of monitoring a plurality of terminals that are accessing content on a plurality of computer units, comprising:
each of the computer units determining an identity of each terminal presently accessing it and the content they are accessing;
transmitting that information to each of the other terminals;
each terminal making available said information about the other terminals.

Each of the computing units (e.g. web servers) transmits information concerning the activities of the individuals who access them. In principle, this information may be transmitted to a central cache location which in turn makes it available to each of the individuals. The information may be transmitted by each of the computing units in real time directly to each of the other computing units which in turn makes this available to the terminals accessing them. As a further preferred alternative, each of the terminals may be arranged to receive this information directly from other terminals, and to transmit its own identity and an indication of the content it is accessing to the other terminals.

This last technical concept is the basis of a second independent aspect of the invention, which proposes in general terms that each of a plurality of terminals should directly transmit to each other in real time information about the instantaneous activities of any of a plurality of individuals who are interacting with the terminals.

Specifically, the second aspect of the invention proposes a terminal for monitoring a plurality of other terminals that are accessing content from a plurality of computer terminals, comprising:
means for receiving information identifying the other terminals and the content they are presently accessing; and
means for making available the information about the other terminals.

Preferably the terminal further comprises means for transmitting information identifying said terminal and the content it is presently accessing to the other terminals.

In any aspect of the invention, the plurality of computing units may be servers. For example they may be web page servers to which the individuals are connected by Internet communication, using their terminals. Alternatively, the plurality of computing units may be units which the individuals are accessing as a means for communication with further servers. For example, the plurality of servers may be Internet Service Providers (ISPs).

A third aspect of the invention proposes in general terms that a first individual who is a member of a defined set of individuals operates a browser adapted to receive data indicating sites which other of the set of individuals are accessing. Based on this data the first individual may be able to select a site to access, e.g. based on options offered to him using the data.

Specifically, in this third aspect the invention proposes a method for displaying to an individual the activities of a plurality of other individuals, the method including:
establishing a connection between a terminal device operated by the individual and a computing unit;
receiving from the computing unit information identifying for each of the plurality of other individuals content which those individuals are presently accessing, and
collating and displaying the information to the individual.

Instead of establishing a terminal computer unit connection, the connection may be directly between terminal devices.

In general, embodiments of the invention may be established using software installed on the computer units and terminals, or just on the terminals which form part of the set or swarm.

Note that the various aspects of the method are freely combinable, as are their various preferred features.

Furthermore, although embodiments of the inventions are expressed above as either methods or apparatus, they may also be expressed as computer apparatus arranged to perform or permit the methods or methods which the apparatus carries out, or as software (i.e. a computer program product, such as computer instructions stored on a recording medium and readable by computer apparatus) which causes the computer apparatus to perform or permit the methods.

### BRIEF DESCRIPTION OF THE DRAWINGS

Non-limiting embodiments of the invention will now be discussed for the sake of example only with reference to the following figures in which:

FIG. 1 shows schematically an arrangement according to a first embodiment of the invention; and

FIG. 2 shows schematically a window displayed by a browser program product which is an embodiment of the present invention.

### DETAILED DESCRIPTION OF THE EMBODIMENTS

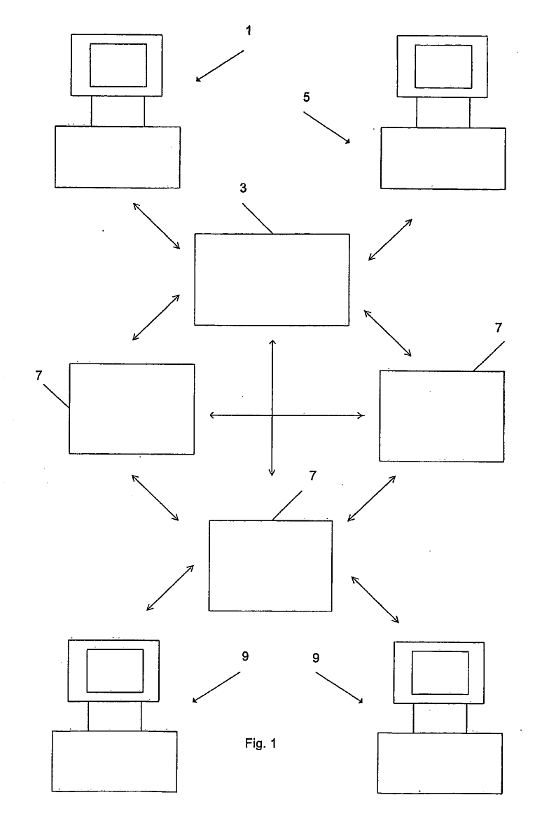

Referring firstly to FIG. 1, a first embodiment of the invention will be explained with reference to the activities of an individual who accesses one of a set of distributed computing units 3, 7.

In most embodiments each individual is associated with at least one terminal device, and uses this terminal device to access the computing units. The terminal device may be a conventional personal computer, but the invention is not limited in this respect, and the terminal may alternatively be any user operable device, such as a mobile telephone or even a television remote control device.

In much of the following discussion no distinction is made between the individual and his terminal device, so that FIG. 1 indicates this individual schematically by a representation of a typical terminal device (a PC in fact) labelled by the reference numeral 1. This is however, a simplification, in that there is no reason why an individual 1 may not have at his disposal multiple terminal devices with which he can participate in the embodiment (even with more than one terminal device active at the same time). The embodiment may treat such an individual as a single individual having two terminal devices (as assumed below) or as two separate individuals.

At the moment illustrated in FIG. 1, the individual 1 (i.e. his terminal device) accesses a computer unit 3. The term “access” is used here to mean being in two-way communication. It covers for example a situation in which the individual 1 obtains computing services from the unit 3. Initially, we will assume that the computer unit 3 is a web-server, that the communication between the individual 1 and the server 3 is over the Internet, and that the “accessing” is the sort of interaction common on the Internet: in which the server 3 transmits data to browser software running on the terminal device of the individual 1. Below, however, we show that any one or more of these assumptions may be varied within the scope of the invention. In particular, the invention is not limited to Internet use, and the accessing of websites. As mentioned above, the invention may also be used on other networks, such as local area networks, for accessing sites stored thereon.

FIG. 1 also shows other individuals 5, 9 interacting with the server 3 by their respective terminal devices.

The unit 3 is in communication (e.g. over the Internet) with a plurality of other computing units 7, which can be geographically distributed. In this document the term “geographically distributed” will be used to imply that units 3, 7 are in spatially separated locations, such as locations in different counties, cities or even countries. The term may alternatively be defined as meaning that the units 3, 7 communicate via a telecommunications network, normally one which is not proprietary. The most obvious example of such a network is the Internet. As a further alternative, the computer units may be part of the same Intranet, and may even be in the same room.

As shown in FIG. 1, the servers 7 are accessed by other individuals 9 operating respective terminal devices associated with them (for simplicity only two such individuals 9 are illustrated, accessing a single server 7). Again, each of these individuals 9 and their respective terminal devices are indicated as a single element of FIG. 1.

It is to be understood that although the invention will be discussed below from the point of view of the individual 1 who accesses server 3, the other individuals 5, 9 are logically equivalent to the individual 1 and the other servers 7 are to equivalent to the server 3.

Any of the individuals 1, 5, 9 may at any time cease to be in communication with one of the units 3, 7, and instead begin to access another of the servers 3, 7, or indeed cease accessing any of the servers.

We will assume that the individuals 1, 5, 9 have a predetermined logical relationship according to which they are all part of a set called here a “swarm”. The details of how this swarm is initiated are discussed below. Each of the units 3, 7 is aware of the definition of the swarm (i.e. the list of individuals who constitute the membership of the swarm), and is capable of recognising when individuals of the swarm access that unit. For example, each of the servers may contain, for each of the individuals of the swarm a list of the terminal devices associated with the individual, so that the fact that the unit 3,7 enters communication with a given one of the devices may be taken as an indication that that unit is in communication with the corresponding one of the individuals 1, 5, 9 of the swarm. Note that the recognition process may if desired be more sophisticated than this; for example if any of the terminal devices is to be used by more than one individual, a given individual 1,5, 9 may indicate his or her identity to the terminal device which he or she operates and that device may forward that identity to any of the units 3, 7 which it accesses.

Note that FIG. 1 merely indicates the functioning of a single swarm. In practice there may be multiple swarms (i.e. multiple sets of individuals). These sets need not be mutually exclusive; in other words any individual (and hence his device) may belong to more than one of the swarms. Any individual who is a member of at least one swarm is here referred to as a registered individual.

The servers 3, 7 are arranged to recognise the presence of devices associated with any of the registered individuals. The servers 3, 7 may furthermore interact at any time with terminal devices operated by individuals who are not registered individuals (i.e. people who are not associated with any of the swarms). These individuals are not shown in FIG. 1.

Each of the units 3, 7 transmits at intervals (e.g. periodically) a transmission to the other servers 3, 7 indicating which of the registered individuals 1, 5, 9 are at that time accessing that unit 3, 7. Preferably, the transmissions a re sent with intervals of at most 30 seconds, or at least 10 seconds. At the same time, to avoid excessive traffic being generated, the transmissions are preferably at intervals of at least one second. In practice, we presently recommend that an interval of about 3 seconds is used.

The transmissions may be in any format which is commonly understood by computer units, such as XML. That is, the transmission may be a data packet indicating the unit 3, 7 which transmitted it, the unit 3, 7 to which it is directed and an embedded command in XML.

The command may for example have the form:
<user>1010<xyz>1011<xyz> . . .

Here the XML tag <user> is defined within the embodiment, and is recognisable by the servers 3,7, to indicate that the packet is one of the transmissions discussed above. The tag <user> is followed by a (binary) code number 1010 indicating the identity of a first of the individuals 1, 5, 9 connected to the server 3,7 which sent the transmission. It is followed by a tag <xyz> containing further information known to the server 3, 7 which sent the transmission and indicating further information about the individual coded as 1010, such as the content or site, for example, website it is accessing. This is followed by a further code number 1011 indicating the identity of another of the individuals 1, 5, 9 interacting with the unit 3, 7 which sent the transmission, and a corresponding further tag <xyz>, indicating for example the site, website or server this individual is accessing. The command contains a code number, and a corresponding tag <xyz>, for each of the registered individuals 1, 5, 9 interacting with the unit 3, 7 which sent the transmission. Even in the case that multiple swarms of registered individuals have been defined, each unit 3, 7 preferably sends a single transmission to each of the other units 3, 7 which indicates all the registered individuals which are presently interacting with that unit 3, 7, irrespective of the swarm(s) to which they belong.

Each of the units 3, 7 maintains an internal database indicating for each of the registered individuals the most recent information concerning that registered individual received from each of the other units 3, 7.

Note that in this preferred form of the invention there is no “central” unit (e.g. server) to which all the other units 3, 7 transmit their information and which distributes the information it accumulates back to those units 3, 7. Although this possibility is not excluded by certain aspects of the present invention, it suffers from the disadvantage that if the central unit fails, the entire monitoring process can fail. By contrast, in the decentralised model illustrated in FIG. 1 the failure of any one of the units 3, 7 is no impediment to the monitoring by any other of the units 3, 7 of the activity of the set of individuals 1, 5, 9 who access any of the other functioning units 3, 7.

However, although preferably no central unit is involved in the actual operation of the embodiment shown in FIG. 1, a single computing unit (say unit 3) may be used to set up the swarms. For example, a number of individuals may contact the unit 3 requesting to join the membership list of a swarm. Each individual may supply details of the device(s) they will be using to access the Internet.

As a further alternative, the functions of the units 3, 7 may be implemented in the individual terminals 1, 9, the units 3, 7 then merely being passive elements of the network connecting the individuals together. In this alternative embodiment the individual terminals 1, 9 comprise software arranged to transmit the above mentioned packets to each other periodically. Each swarm may be predetermined without reference to the units 3, 7 by for example a group of friends registering each other as part of a swarm by entering the group member's Internet Addresses. Each individual terminal 1, 9 is then able to transmit and receive the above mentioned packets to enable monitoring of the swarm's activities. As a further alternative the swarms may be allocated by a central database of users, perhaps grouping members of each swarm according to criteria such as hobbies, age, etc.

The unit 3 groups these individuals into one or more swarms. For example, unit 3 may initially define each swarm as a random selection of a predetermined number of randomly chosen individuals. We presently envisage that the number of individuals in a swarm may be limited to be up to 100, up to 200 or up to 500. Preferably the number of individuals in a swarm is at least 50, at least 100 or at least 200.

Alternatively, the unit 3 may use criteria based on characteristics of the individuals (interests, ages, genders, etc) for deciding which individuals are to be grouped together to define a swarm.

Alternatively, a group of individuals may contact the unit 3 requesting that a swarm should be set up to include them. The swarm may for example be set up based on the membership of an existing set of individuals, such as an existing club, or a school.

For each of the swarms defined in this way, the unit 3 sends to each of the other units 7 a file containing the information supplied by each of the individuals of that swarm, preferably including enough data to recognise those individuals when they begin to access one of the units 3, 7. Furthermore, the unit 3 retains a copy of the file for its own use. This file is thus the definition of a swarm. Using this file, each of the servers or units 3, 7 is able to monitor whether any of the individuals of the swarm is presently accessing it.

Subsequently, the membership of the swarm may be permitted to change. For example, an individual who wishes to register as part of a n existing swarm may contact unit 3 and request admission to a swarm. The unit 3 may decide which swarm would be appropriate (e.g. such that the criteria previously used to generate the swarm match the new individual's characteristics and/or such that the predetermined maximum number of individuals in the swarm is not exceeded). Alternatively, the individual himself may request admittance to a particular swarm which he identifies (e.g. because certain friends of his are already members of it). Similarly, the unit 3 may be able to delete members from a swarm (e.g. because the individual's characteristics no longer match the criteria used to define the swarm). In any of this cases the redefinition of the swarm can be performed by the unit 3 transmitting to the other units 7 an updated file defining the updated swarm.

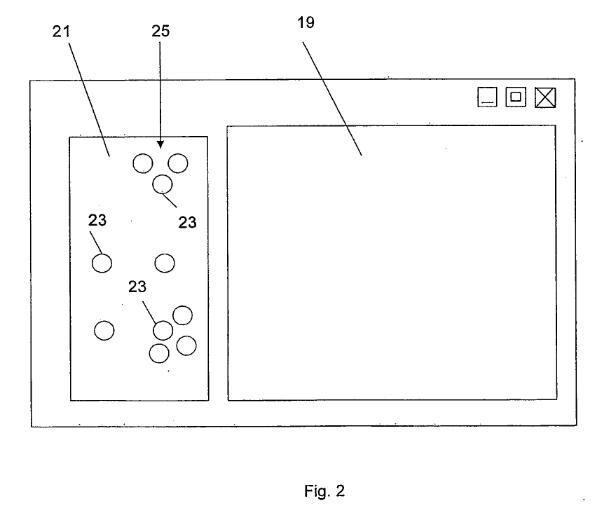

Turning to FIG. 2, a browser window is shown illustrating how the individual 1 can employ the information he or she receives about the activity of the other individuals of his own swarm in the case that the units 3, 7 are servers supporting one or more websites. The right portion 19 of the window is a conventional area for displaying a given web page. This portion 19 of the window may also be used to display a list of various available swarms and links thereto.

The left hand portion 21 of the window (which can be displayed or hidden as desired) displays dots 23, or alternative icons, each dot or icon corresponding to a respective one of the individuals of the swarm to which the individual 1 belongs. A variety of icons could be used by individuals to denote their identity or even represent graphically the current mood of the individual (emoticons). Furthermore, individuals may be able to change the icon or colour representing their own identity or that of others, if desired. Note that in the case that the individual 1 is a member of more than one of the swarms, the individual 1 normally makes a selection of one of the swarms of which he or she is a member, and the display in region 21 is generated based on the individuals of that selected swarm. Note that it is optional to include a dot representing the individual 1 himself or herself.

The dots 23 are positioned in the region 21 such that, if multiple individuals of the swarm are presently accessing a single one of the servers 3, 7 (or a single site defined by one of the servers 3, 7), then the respective dots representing those individuals form a cluster (such as cluster 25) in the area 21. The dots 23 of this cluster may, for emphasis, also be displayed with the same colour. For ease of identification, on a particular individual's display, the dot representing that particular individual may be displayed in a different colour from the other individuals in the swarm. In the case of individuals of the swarm who are the only individuals of the swarm to be accessing a particular server 3, 7 (or a particular site supported by one of the servers 3, 7), the dots 23 which represent those individuals are isolated in the area 21.

In a preferred embodiment, a visual indication may be included in the region 21 to indicate the length of time individuals in the swarm maintain their access to a single one of the servers 3, 7 (or a single site, for example a website) in a particular swarming session. For example, an icon such as a blooming flower may be displayed if a cluster of individuals remain accessing a particular server or single site or website for more than a predetermined period of time, such as five minutes. As individuals in the cluster move out of the cluster, the icon may change to indicate the departure of the individual(s) from the cluster. In the example of the blooming flower, the flower icon could be arranged to fade or wither as the individuals leave the cluster.

Various other means of signifying movement within a swarm may be included, for example, sounds may be emitted to signify the entering of an individual into a swarm or the departure of an individual from a swarm.

The size and/or appearance of the visually displayed regions 19 and 21 of the window shown in FIG. 2 may be altered, as desired, for example, to minimise, reduce or enlarge one or other of the displayed regions 19 or 21, or otherwise change the appearance of the region(s), for example, the displayed background, which could also be used to display other information such as messages. These alterations could be performed by an individual of the swarm or by the service provider and could be effected locally on an individual's terminal device or globally across all of the terminal devices of the members in the particular swarm.

In a preferred embodiment, region 21 could be moved out of the web program for an individual and stored in another function or system within an individual's terminal device.

The graphical representation shown in FIG. 2 is to be regarded as purely exemplary, and the invention is not limited to such a graphical representation. Although the clustering shown in FIG. 2 is a particularly efficient and intuitive way of indicating similarities in the activities of a plurality of individuals, there are in fact a number of logically equivalent ways of indicating similarities in the activities of a plurality of individuals.

If the individual 1 notices a cluster 25 of dots 23, he or she can use that information in multiple ways. For example, he may issue a command (e.g. a mouse click on the cluster) to the browser to open the site at which the clustering occurs in portion 19 of the window (e.g. the homepage of that site would be displayed in area 19). Alternatively, the individual may issue a command to record the identity of the site at which the clustering occurs, for future analysis.

Alternatively, or additionally, the individual operating device 1 may be able (e.g. by issuing a command) to obtain more detailed information about the site, and the activities of the individuals who are interacting with it. For example, the individual may be able to change the “resolution” of the portion 21 of the window, so that the entire portion 21 is used to represent a single server (or a single website), and a cluster of dots indicates that individuals are clustered at a single page of the website. By clicking on this cluster, the page where those individuals are clustered will be displayed. In this way, the individual is able to navigate not only to a site which is popular with his or her swarm, but also to a particular page which is popular with his or her swarm.

The server 3 which the individual 1 is accessing may already have this further information (because it is included in the regular transmissions described above sent within the network of FIG. 1). Alternatively, the server 3 may be able to obtain this information by interrogating the server 7 which supports the site at which the other individuals are clustered.

Another way in which the individual 1 can use the information presented by the window shown in FIG. 2 is to identify another individual of the swarm having particularly interesting characteristics, and select that interesting individual. For example, it may be possible to retrieve information (e.g. personal information, such as a user name or an assigned nickname or other available information) about any of the individuals using the representation in the portion 21 of the window (e.g. by clicking on the corresponding dot). Alternatively, the individual 1 may be able to identify that another individual 5, 9 of the swarm is interesting just because he tends to be found at interesting websites. In any case, once the individual 1 has identified that another individual 5, 9 is interesting, he may issue a command (e.g. to his browser) that the individual 5 is to be monitored in more detail. For example, the portion 19 of the window of FIG. 2 may be automatically updated to show at any time the webpage or site, for example website, which the selected individual 5, 9 is presently viewing, so that that individual is effectively tracked (or “stalked”). The information regarding the movements of the individual being followed may be displayed, for example, adjacent the dot representing the individual being tracked in the portion 21 of the window of FIG. 2. Furthermore, the appearance of the dot or icon identifying the individual being tracked may change to indicate that this individual is being tracked.

The individual who initiated the command to track another individual may, at any time, select to cease following the tracked individual. Any individual 1 may be able to find out which other individuals 5, 9 have marked him or her out in this way. It may furthermore be possible for the individual 1 to issue a command to disable the ability of other individuals 5, 9 to track the individual 1. The server 3 with which the individual 1 is interacting may transmit to all the other servers 7 the fact that the individual 1 has issued this command; optionally, it may be transmitted in turn to the browser programs of all the individuals 5, 9. The servers 3, 7 (and/or browser programs) should be arranged to observe the wishes of the individual 1 by refusing to perform tracking of that individual 1.

As a corollary to this function, an individual may drag others along with him or her in a “tutorial” mode. Thus the individual selects other individuals which then follow him such that their browsers display the same site or webpage that the “tutor” individual is accessing.

An individual within a swarm may be rated or ranked by other members of the swarm and his rating or ranking may be depicted graphically in the display region 21 of the window shown in FIG. 2. This enables either the popularity of an individual or his expertise in a particular field to be indicated to the other individuals in a swarm. The visual representation of an individual's rating or ranking may, for example, by indicated by a change in colour or other appearance of the dot or icon representing the individual which is displayed in the region 21. An individual's ranking within a swarm may be determined by, for example, noting the number of times each individual is tracked by other individuals or selected by other individuals seeking further information about that individual. In this way, the status or ranking of all of the individuals in a swarm may be continuously monitored and displayed.

As mentioned above, an individual in a swarm may be rated by other members of the swarm to indicate, for example, his expertise in a particular field. An individual's rating may influence his ranking in the swarm.

In a preferred embodiment, an individual in a swarm may send a message to another individual in the swarm. The message, or an indication that a message has been sent to a particular individual, may be displayed in the portion 21 of the window of FIG. 2 of the display of the individual to whom the message was sent. The other individuals in the swarm may not receive an indication that a message has been sent nor be able to access the content of the message. The message may be displayed, for example, adjacent the dot representing the individual from whom the message originated. The recipient of the message may then choose to read the message if only an indication of a message having been sent is displayed initially, reply to the message, or ignore the message.

In a further embodiment, group messaging by a particular swarm may be possible. An area such as a window or other gateway in regions 19 or 21 of the window shown in FIG. 2 may be allocated to displaying messages to the swarm as a whole, that is to all members of a swarm, and/or may provide an area in which outgoing messages may be written by members of the swarm. The area may be arranged to be continuously available for use.

It may also be possible for individuals within a swarm to signal other individuals within the swarm, for example to attract attention. The signal may include a sound, or a change in visual appearance of the individual's icon such as causing the icon to flash (or “wink”) on the display, or it may comprise the display in region 21 of a message from the individual seeking attention.

An individual in a swarm may select one or more individuals in the swarm as “buddies”. The selection of an individual as a “buddy” may be indicated by a change in the visual appearance of the icon representing the selected individual(s), such as a change in colour or otherwise. This enables the other individuals in the swarm to identify “buddies” in the swarm. A list may be created, maintained and displayed recording the identity of “buddies” in a swarm and this list may be accessible by the members of the swarm.

An individual in a swarm may allocate a name or ‘tag’ to one or more other individuals in the swarm to enable easy identification of various individuals in the swarm. The tag may include a nickname and/or the current URL being viewed by the tagged individual and may be displayed adjacent the dot or icon representing the tagged individual in the portion 21 of the window of FIG. 2 for the duration of the session, or less, if desired.

In a preferred embodiment, an individual may choose to prevent his movements and the dot or icon representing himself from being displayed to one or more selected other individuals in a swarm or from the entire swarm, thereby concealing the individual's activities from the swarm or selected members thereof for as long as desired. Also, an individual may choose to inhibit, simultaneously or otherwise, the display of one or more dots or icons representing selected other individuals in a swarm. In this way, individuals may choose to mutually exclude themselves and selected other individuals from being displayed in the portion 21 of the window for the current session.

An individual may provide a profile page giving details of himself or his preferred sites. These details may be provided by the individual, for example, when applying to become a member of a swarm and may be updated by the individual over time. An individual's profile page may be available for viewing by other members of the swarm of which the individual is a member.

The above described functions may be activated by, for example, an individual issuing a command such as a mouse click on the dot or icon representing himself or another individual in the swarm. On issuance of the command, such as clicking of the mouse button, a list of available options may be displayed in a sub-window in the portion 21 of the window of FIG. 2. The list of available options may include the terms “message” which, when selected by, for example, another click of the mouse, causes the display of a further sub-window in which a message may be typed and the instruction to send the message to the selected recipient.

The option of tracking a selected individual may be selected or de-selected by selecting the “follow” option which may be displayed in the above-mentioned list. The option of naming a particular individual in a swarm may be selected by selecting the “name/URL” option given in the list, and the feature of ignoring a selected individual may be activated or deactivated by selecting the “ignore” option in the given list.

The option of selecting an individual to become a “buddy” may be selected or de-selected by selecting the “make buddy” option which may be displayed in the above-mentioned list.

The option of viewing an individual's profile page may be selected or de-selected by selecting the “profile” option which may be displayed in the above-mentioned list.

The position in the portion 21 of the window of FIG. 2 of the dots or icons identifying each individual in a swarm or clusters thereof may be random and not representative of any particular characteristic of the swarm or individuals therein. Alternatively, the positioning of the dots or icons representing individuals in a swarm or clusters thereof may be arranged to indicate, for example, the relationship between websites which have been visited. In this embodiment, the distance between individual dots and/or clusters thereof may be indicative of the sites, for example websites, visited in a session. The displayed distance between dots representing individuals and/or clusters thereof could be arranged to decrease as the movement of dots and/or clusters therebetween increases.

In a further embodiment, the dots and/or clusters thereof could be arranged in a grid, and each square of the grid may correspond to a letter of the alphabet. The grid may or may not be displayed in the portion 21 of the window of FIG. 2. The first letters of names of the sites, for example websites, visited by individuals or clusters thereof in a swarm, or the most popular sites, for example websites, visited, may be noted by the system and the dots representing individuals or clusters who visited those sites may be shown in the relevant portion of the grid.

In a further embodiment, a visual representation may be included in the display region 21 of the window shown in FIG. 2, for example, a colour bar, the position and/or colour(s) of which may indicate activity of a particular swarm and/or links to areas such as other swarms or sites, for example, websites, which may be of interest to the swarm. By way of example, the colour bar could contain a number of colours, each colour indicating a particular site, for example, website being visited by the swarm. The particular colours within the colour bar could be arranged to signify the popularity of the site, for example, red signifying the most popular site. Also, the position of a coloured area within the colour bar may signify the activity or popularity of a particular site denoted by that colour. This is advantageous as it provides instant visual indication of the activity of a swarm in real-time.

Furthermore, if an individual issues a command such as a mouse-click, on a particular location on the colour bar, this may immediately connect the individual to either a corresponding site within the swarm denoted by the colour selected or direct the individual to various sites or swarms denoted by the colour selected.

In a preferred embodiment, a swarm may impose restrictions on its members limiting the sites, such as websites which may be viewed by the members as part of a swarming session. This provides a filtering mechanism whereby a swarm can control the types of information accessible to the swarm as a group during a swarming session. One advantage of this is that swarming sessions may be limited to sites likely to be of interest to members of the particular swarms and also prevent unsuitable material from being viewed as a group during a swarming session thereby maintaining a form of quality control.

The above-described filtering method may be achieved by, for example, maintaining a list of the sites, for example websites, available or unavailable to members of a swarm as part of a swarming session. The members may be able to suggest sites which are to be included on the list and, for example, the site owner or service provider could decide which sites are to be included on the list.

Every movement of the individuals in a swarm during a swarming session would be monitored to determine if they are attempting to access a site which is on the list prior to showing their dot/icon on the monitors of other individuals in the swarm. If it is determined that an individual is attempting to access a site which it has been predetermined not to be accessible by a particular swarm during a swarming session, the individual may access the site but the other individuals in the swarm will not be able to follow that individual to the site as part of the swarming session and will not receive information advising them of the site being accessed by that individual.

The list may be directed either to sites which are accessible to all members of a particular swarm during a swarming session or to sites which members are prohibited from showing during a swarming session.

An individual may also decide to impose a restriction on the visibility of his movements to other members of the swarm during a swarming session. An individual may therefore decide the sites or websites where he is to be visible to others or invisible.

In a preferred embodiment, the activities of a swarming session are recorded for a predetermined period of time, to provide a list indicating, for example, the most popular sites, for example websites, visited by the members of the swarm during that time period. The list could be a graphical or textual representation of the sites visited. Such a list may be useful to members as a means of providing qualified feedback.

Many variations of the embodiments described above are possible which are within the scope of the invention. These variations are freely combinable in any combination. A number of examples of possible variations will now be described.

Firstly, the set of units 3, 7 may not be (at least, may not all be) servers with which the individuals 1, 5, 9 are interacting using the Internet. Rather, the individuals 1, 5, 9 may access the units 3, 7 by another (e.g. telecommunications) network.

For example, any one of more the units 3, 7 may be ISPs to which the terminal devices of the individuals 1, 5, 9 connect when they wish to access the Internet. In this case, the fact that any of the devices 1, 5, 9 are presently connected to one of the servers 3, 7 means no more than that those devices are accessing the Internet.

As a further example, any one of more the units 3, 7 may be providers of a telecommunication network such as mobile telephone providers or providers of SMS messaging. The terminal devices 3, 7 would then be mobile telephone devices or SMS messaging devices. The units 3, 7 may indicate to the other units 3, 7 the identities of the persons with whom the individuals 1, 5, 9 are communicating (at least in the case the persons are registered individuals, e.g. of the same swarm).

As a further example, any one or more of the units 3, 7 may be providers of entertainment services, and the terminal devices of the individuals 1, 5, 9 could be devices adapted to receive these services, such as televisions (optionally including remote control devices). In this case, the units 3, 7 may indicate to the other units 3, 7 which entertainment services the individuals 1, 5, 9 are accessing.

Secondly, any of the units 3, 7 may directly transmit to each other more information about the instantaneous activities of the individuals 1, 5, 9 than simply whether those individuals are accessing the units 3, 7. Indeed, the set of individuals 1, 5, 9 may include individuals whose terminal devices have a permanent connection to the units 3,7, so that the fact that this connection exists may not be of sufficient interest to be worth including in the transmissions between the units 3, 7. As an example of the further information which the units 3, 7 may transmit, suppose that the individual 1 accesses a unit 3 (e.g. if unit 3 is an ISP) to access a website supported by a server which may or may not be one of the units 7; in that case the ISP 3 may circulate to the other units 7 the URL which the individual 1 is presently accessing.

In fact, although the invention has been described above mainly in terms of monitoring which Internet websites individuals access at any time, the concept of swarming (i.e. providing to each individual of a predetermined set of individuals real time information about the other individuals of the set) is much broader than this and applies in principle to any other form of real time information. For example, the information can comprise a real-time measure of the mood of each individual (“happy”, “discontented”, etc.). by, for example, the appearance of the icon representing the individuals in the swarm (an emoticon).

Alternatively or additionally, the information may include information about the present activity of the individual 1, e.g. whether the individual is telephoning or SMS messaging (and if so with whom, e.g. another member of the swarm), playing a game (and if so with whom, e.g. another member of the swarm), word-processing, etc) or using the individual's terminal device. Note that this activity need not be limited to activities involving the unit 3. Instead the terminal device may pass this information to the unit 3 as an incidental part of the operation which the terminal device performs to carry out the individual's main activity. This variation permits members of a swarm to track the present activity of the other members.

Clearly, in all aspects of the invention, security is an important issue. In general, the individuals should preferably be able to disable any or all of the monitoring options carried out on them by other members of the swarm.

In a further preferred embodiment, the concepts described above may be applied to a product selling scheme such as an auction between members of a swarm which is held during a swarming session. The swarming field depicted by region 21 of the window shown in FIG. 2 could be arranged to display graphically, for example in the shape of a pyramid which has been divided into blocks by grid lines, the status of the bidding, each bid being placed in a block of the pyramid. The product(s) being sold could also be depicted graphically in the display window together with an indication of the actual time or the time elapsing during the selling process. Holding numbers could be allocated to each individual participating in the sale and the bids placed by those individuals could be displayed, for example, adjacent the row of the pyramid in which the amount of his bid falls. The bids of individuals could be displayed in real time in, for example, a text window which is displayed for a period of time next to the icon representing the individual. The profile page of individuals bidding during the sale or of the individual(s) selling a product could be accessed by the other members of the swarm to provide information on the seller or competitors in the bidding process. The profile page could also give an indication of the status of the individual, for example, whether he is a buyer or a seller.

In a further preferred embodiment, should the members of a swarm during a swarming session visit a site, for example a website, marketing a product or products, the icons representing the individuals in the swarm may be displayed around a product being marketed on the site forming a cluster around the product(s). Various representative symbols may be displayed to the members of the swarm indicating, for example, their views on the products being marketed, the credibility of the members of the swarm in the cluster and the recent buying history of the members in the cluster.

1. A method of monitoring a plurality of terminals that are accessing content from a plurality of computer units, comprising:
each of the computing units determining an identity of each terminal presently accessing it and the content they are accessing; each of said terminals being indicated to said other terminals or computer units as a graphical symbol;
transmitting that information to each of the other terminals or computing units;
each terminal or computing unit making available said information about the other terminals; said method further comprising:
selecting for display content presently being accessed by one of said other terminals by selecting the symbol associated with said terminal.

2. A method as claimed in claim 1 wherein said content is one or more sites, for example websites, on each said computer unit.

3. A method as claimed in claim 1 wherein said information is made available by displaying a graphical representation indicating correlations between the content accessed by the other terminals.

4. A method as claimed in claim 3 wherein said symbols are grouped according to the content their corresponding terminals are presently accessing.

5. A method as claimed in claim 4 wherein said grouping is by proximity.

6. A method as claimed in claim 4 further comprising a terminal selecting for tracking said symbol in order to display the content accessed by the associated terminal in the future.

7. A method as claimed in claim 4 further comprising a dominating terminal selecting a number of said symbols to be dominated, the terminals associated with said selected symbols displaying the same content that the dominating terminal is accessing.

8. A method as claimed in claim 1 in which each of the computer units transmits the information directly to the other computer units.

9. A method as claimed in claim 1 in which each of the computer units transmits the information to the other computer units by first transmitting it to a central location, which transmits its accumulated information to the other terminals.

10. A method according to claim 1 further comprising for each of the terminals limiting the transmission to each of the other terminals of information regarding the content being accessed by each of the terminals to predetermined content.

11. A method according to claim 1 further comprising arranging one or more of the terminals to enable transmission of information from said one or more terminals to one or more of the other terminals to draw attention to the terminal transmitting the information.

12. A method according to claim 1 further comprising providing to one or more of the terminals means for accessing information regarding the one or more terminals, such as a profile of a user of the terminal.

13. A terminal for monitoring a plurality of other terminals that are accessing content from a plurality of computer terminals, comprising:
means for receiving information identifying the other terminals and the content they are presently accessing; each of said terminals being indicated to said other terminals as a graphical symbol;
means for making available the information about the other terminals; and
means for selecting for display content presently being accessed by one of said other terminals operable by selecting the symbol associated with said terminal.

14. A terminal as claimed in claim 13 further comprising means for transmitting information identifying said terminal and the content it is presently accessing to the other terminals.

15. A terminal as claimed in claim 14 wherein said transmission means either directly transmits said information to the other terminals or transmits said information to a central location, which then transmits its accumulated information to the other terminals.

16. A terminal as claimed in claim 13 wherein said content is one or more sites, for example websites, on each said computer unit.

17. A terminal as claimed in claim 13 wherein said information is displayed as a graphical representation indicating correlations between the content accessed by the other terminals.

18. A terminal according to claim 14 further comprising means for limiting transmission to the other terminals of information regarding the content being accessed by the terminal to predetermined content.

19. A terminal according to claim 14 further comprising means for enabling transmission of information from one or more of the terminals to one or more of the other terminals to draw attention to the terminal transmitting the information.

20. A terminal according to claim 14 further comprising means for accessing information regarding the one or more terminals, such as a profile of a user of the terminal.

21. A method for displaying to an individual the activities of a plurality of other individuals, the method including:
establishing a connection between a terminal device operated by the individual and a computing unit or one or more terminal devices operated by the other individuals;
receiving from the computing unit or the other terminals information identifying each of the plurality of other individuals and content which those individuals are presently accessing; each of said individuals being indicated as a graphical symbol;
collating and displaying the information to the individual; and
selecting for display content presently being accessed by one of said other individuals by selecting the symbol associated with said individual.

22. A method as claimed in claim 21 wherein the content is one of a plurality of sites, for example websites.

23. A method according to claim 21, further comprising limiting transmission to the other terminals of information regarding the content being accessed by the terminal to predetermined content.

24. A method according to claim 21 further comprising arranging one or more of the terminals to enable transmission of information from said one or more terminals to one or more of the other terminals to draw attention to the terminal transmitting the information.

25. A method according to claim 21 further comprising providing to one or more of the terminals means for accessing information regarding the one or more individuals, such as a profile of the individual.

26. A device for operation by an individual, the device including:
a display unit;
means for establishing a connection with a computing unit;
means for receiving from the computing unit information identifying each individual;
means for displaying a graphical symbol indicating the identity of each individual;
means for selecting and displaying for each of a plurality of individuals content which those individuals are presently accessing on selection of the symbol associated with said individual;
means for using the display unit to display information collating the information.

27. A device according to claim 26, further comprising means for limiting transmission to each of the individuals of information regarding the content being accessed by any one of the individuals to predetermined content.

28. A device according to claim 26 further comprising means for displaying on the display unit information from one or more individuals to one or more of the other individuals to draw attention to the individual transmitting the information.

29. A device according to claim 26 further comprising means for accessing information regarding the one or more individuals, such as a profile of the one or more individuals.

30. A computer program product comprising instructions readable by a computer terminal to implement a method for monitoring a plurality of other terminals that are accessing content from a plurality of computer units, the method comprising:
receiving information identifying the other terminals and the content they are presently accessing;
making available the information about the other terminals.
selecting for display content presently being accessed by one of said other terminals by selecting a symbol associated with said one of said terminals.

31. A computer program product according to claim 30 further comprising transmitting information identifying said terminal and the content it is presently accessing to the other terminals.

32. A computer program product according to claim 30, further comprising limiting transmission to the other terminals of information regarding the content being accessed by the terminals to predetermined content.

33. A computer program product according to claim 30, further comprising arranging one or more of the terminals to enable transmission of information from said one or more terminals to one or more of the other terminals to draw attention to the terminal transmitting the information.

34. A computer program product according to claim 30, further comprising providing to one or more of the terminals with means for accessing information regarding the one or more terminals, such as a profile of a user of the terminal.

35. A computer unit adapted to be accessed by one or more terminals, the computing unit including:
means for identifying each of the one or more terminals which are presently accessing it and content which each said terminal is accessing;
means for transmitting that information to other computer units or the terminals;
means for receiving corresponding information concerning other computer units;
means for collating that information to derive a database of which of a set of individuals are accessing the computer units;
means for making that database available to each one or more individuals who are presently accessing the computing unit; and
means for selecting for display content presently being accessed by one of said other terminals operable by selecting a symbol associated with said one of said terminals.

36. A computer unit according to claim 35, further comprising means for limiting transmission to the other terminals of information regarding the content being accessed by the terminal to predetermined content.

37. A computer unit according to claim 35, further comprising means for enabling one or more of the terminals to transmit information to one or more of the other terminals to draw attention to the terminal transmitting the information.

38. A computer unit according to claim 35, further comprising means for accessing information regarding the one or more terminals, such as a profile of a user of the terminal.
